(19) United States
(12) Patent Application Publication
(10) Pub. No.: US 2011/0115983 A1
(43) Pub. Date: May 19, 2011

(54) Image Display Apparatus to Which Multiple Image Sources Can Be Connected

(75) Inventors: Kyousuke NISHIHATA, Osaka (JP); Kenji OFUNE, Osaka (JP); Koki YAMAMOTO, Osaka (JP)

(73) Assignee: SANYO ELECTRIC CO., LTD., Osaka (JP)

(21) Appl. No.: 12/950,173

(22) Filed: Nov. 19, 2010

(30) Foreign Application Priority Data
Nov. 19, 2009 (JP) 2009-263788 P

(51) Int. Cl. H04N 5/268

(52) U.S. Cl. 348/705; 348/E05.057

(57) ABSTRACT

A projector has a single-screen display mode in which an image based on a single image signal is displayed and a dual-screen display mode in which images based on two respective image signals are displayed. When an image signal is input only to one input terminal and an image signal is not input to the other input terminal, the projector is set to the single-screen display mode and an image based on an image signal from a PC is displayed in a main screen. When input of an image signal to the other input terminal is confirmed during execution of the single-screen display mode, the projector switches from the single-screen display mode to the dual-screen display mode, so that an image based on an image signal from a PC1 and an image based on an image signal from a PC2 are simultaneously displayed in one screen.

This nonprovisional application is based on Japanese Patent Application No. 2009-263788 filed with the Japan Patent Office on Nov. 19, 2009, the entire contents of which are hereby incorporated by reference.

### BACKGROUND OF THE INVENTION

1. Field of the Invention

The present invention relates to an image display apparatus and more particularly to an image display apparatus to which a plurality of image sources can be connected.

2. Description of the Related Art

An image display apparatus having an automatic switching mode in which single-screen display for displaying an image from one input source in one screen on a display portion and dual-screen display for displaying two images from two input sources in two screens on the display portion respectively are automatically switched and executed is available as an image display apparatus for displaying an image based on an image signal supplied from an external image signal supply apparatus (image source).

In the image display apparatus above, when a selection operation for selecting an input source different from a source of input of the image being displayed is performed while the automatic switching mode is set and single-screen display is executed, a control unit sets dual-screen display in which an image from the input source that has been selected for execution of single-screen display and an image from an input source selected by the selection operation are displayed side by side. According to such a configuration, even when one user is viewing an image in single-screen display and another user performs a selection operation for selecting a different input source, display of that image can reliably be continued.

Here, in recent years, an image display apparatus tends to include a plurality of input terminals and various types of image sources can be connected thereto. Where image signals from a plurality of image sources are input to the image display apparatus, the user has to perform an operation for selecting a desired image source from among these image sources by using an operation portion in a remote controller or the like. For example, for executing dual-screen display as described above, an operation for designating two input terminals from among the plurality of input terminals should be performed.

Since switching between single-screen display and dual-screen display is thus made depending on an operation for selecting an input terminal in the conventional image display apparatus, nothing will be displayed in one screen out of two screens if an image signal from an image source is not input to the selected input terminal.

Therefore, the user has to perform an operation for selecting an image source issuing an image signal, and consequently operability of the image display apparatus was poor.

In addition, in the conventional image display apparatus, unless the user changes setting of dual-screen display, switching between display and non-display in one screen out of the two screens and change in combination of images to be displayed in the two respective screens cannot be made, and hence operability of the image display apparatus was poor.

### SUMMARY OF THE INVENTION

An image display apparatus according to the present invention has a single-screen display mode in which an image based on a single image signal is displayed and a multi-screen display mode in which a plurality of images based on a plurality of image signals respectively are displayed. The image display apparatus includes: an input portion which includes a plurality of input terminals and receives a plurality of image signals supplied from a plurality of external image signal supply apparatuses through the plurality of input terminals respectively; a display portion which displays an image based on the image signal input to the input portion; an image signal detection portion which detects presence/absence of input of the image signal to the input portion; and a control unit which switches an image to be displayed on the display portion based on a result of detection by the image signal detection portion. The control unit includes a first display switching unit which switches between the single-screen display mode and the multi-screen display mode based on presence/absence of input of the image signal to an input terminal other than one input terminal while the image signal is input to one input terminal among the plurality of input terminals.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1(A) and 1(B) are diagrams illustrating an image displayed by an image display apparatus according to a first embodiment of the present invention.

FIG. 2 is a diagram illustrating a configuration of a projector in FIGS. 1(A) and 1(B).

FIG. 3 is a flowchart illustrating an operation of the projector.

FIGS. 4(A) and 4(B) are diagrams illustrating an image displayed by a projector according to a second embodiment of the present invention.

FIG. 5 is a diagram illustrating a configuration of the projector in FIGS. 4(A) and 4(B).

FIG. 6 is a flowchart illustrating an operation of the projector.

FIG. 7 is a diagram illustrating an image displayed by a projector according to a third embodiment of the present invention.

FIGS. 8(A), 8(B) and 8(C) are diagrams illustrating an image displayed by the projector during execution of a dual-screen display mode.

FIG. 9 is a diagram illustrating a configuration of the projector in FIG. 7.

FIG. 10 is a flowchart illustrating an operation of the projector.

FIGS. 11(A) and 11(B) are diagrams illustrating an image displayed by a projector according to a fourth embodiment of the present invention.

FIG. 12 is a diagram illustrating a configuration of the projector in FIGS. 11(A) and 11(B).

FIG. 13 is a flowchart illustrating an operation of the projector.

### DESCRIPTION OF THE PREFERRED EMBODIMENTS

An embodiment of the present invention will be described hereinafter in detail with reference to the drawings. In the drawings, the same or corresponding elements have the same reference characters allotted and description thereof will not be repeated.

### First Embodiment

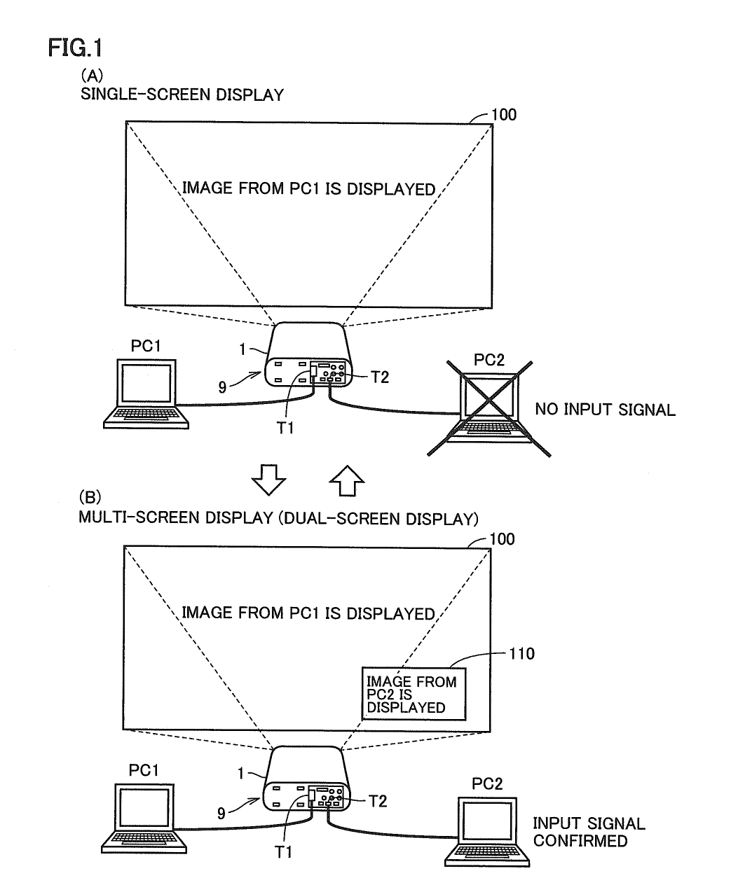

FIGS. 1(A) and 1(B) are diagrams illustrating an image displayed by an image display apparatus according to a first embodiment of the present invention.

Referring to FIG. 1(A), an image display apparatus (hereinafter also referred to as a “projector”) 1 according to the present first embodiment is a liquid crystal projector which projects an image by making use of a liquid crystal device, and it projects (displays) an image by projecting light of an image to be displayed on a projection screen by the liquid crystal device. A projection surface is not limited to a projection screen and it may be a wall surface.

Projector 1 includes an input portion 9. Input portion 9 includes a plurality of input terminals that can receive different types of image signals. In the present embodiment, by way of example, input portion 9 is assumed to include two input terminals T1 and T2.

An external image signal supply apparatus (image source) is connected to input terminal T1, T2 through a transmission path. Examples of image sources include an image source outputting an analog signal, such as a PC (Personal Computer) and a VTR (Videotape Recorder), and an image source outputting a digital signal, such as a DVD (Digital Versatile Disc) reproduction apparatus and a Blu-Ray disc reproduction apparatus. In the example in FIG. 1(A), input terminals T1 and T2 are RGB terminals and adapted to analog RGB signals supplied from a PC1 and a PC2, respectively.

For the sake of brevity of illustration, a signal transmitted from each image source is assumed as an image signal. Though an audio signal is also transmitted together with the image signal, for the sake of brevity of illustration, description of transmission of an audio signal and audio signal processing in projector 1 is not provided.

(Display Mode of Projector)

Projector 1 according to the present embodiment has a “single-screen display mode” in which an image based on a single image signal is displayed and a “multi-screen display mode” in which images based on a plurality of image signals are displayed respectively, as operation modes (hereinafter also referred to as display modes) for displaying an image based on an image signal. In the following, a “dual-screen display mode” in which images based on two respective image signals are displayed is assumed as one manner of the multi-screen display mode.

Switching between the single-screen display mode and the dual-screen display mode is made based on presence/absence of input of an image signal to input portion 9, as will be described below.

Specifically, referring to FIG. 1(A), an example where PC1 and PC2 are connected to input terminals T1 and T2 respectively and image signals from PC1 and PC2 can be input is assumed. In this example, while an image signal is input only to input terminal T1 and an image signal is not input to input terminal T2, projector 1 is set to the single-screen display mode. Therefore, an image based on the image signal from PC1 is displayed in a main screen 100.

Then, when input of an image signal to input terminal T2 is confirmed during execution of the single-screen display mode, projector 1 switches from the single-screen display mode to the dual-screen display mode as shown in FIG. 1(B). Thus, an image based on an image signal from PC1 and an image based on an image signal from PC2 are simultaneously displayed in one screen.

Here, two screens of a screen (main screen) 100 which is a screen displaying one of two images and has a relatively large size and a screen (sub screen) 110 which is a screen displaying the other of the two images and has a relatively small size are assumed. Though sub screen 110 is arranged within a display area of main screen 100 in FIG. 1(B), a manner of arrangement of main screen 100 and sub screen 110 is not limited thereto and they may be arranged side by side. In addition, the screens may be different or identical in size.

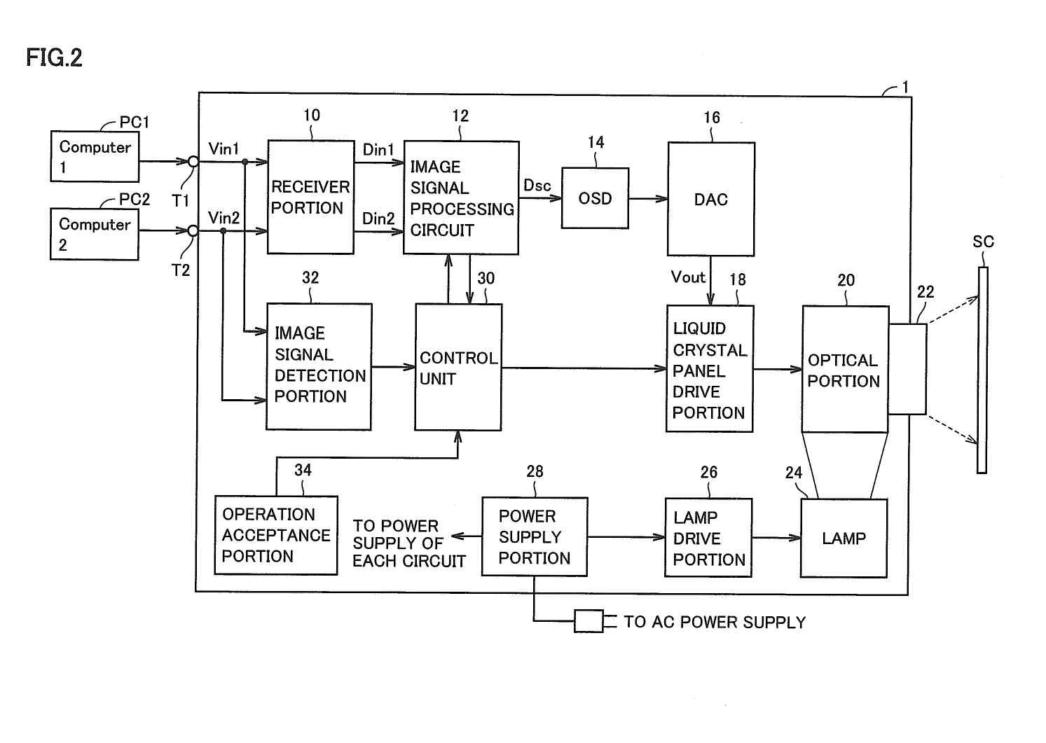

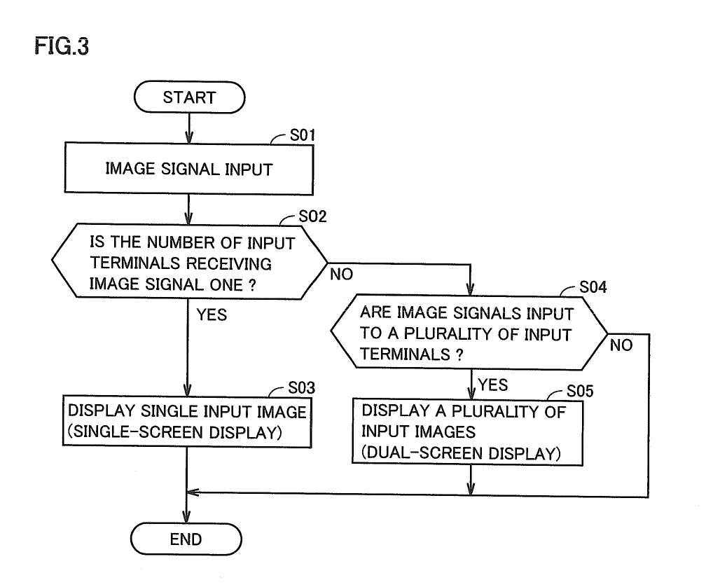

Control for switching between the display modes in the projector according to the first embodiment of the present invention will be described hereinafter with reference to FIGS. 2 and 3.

FIG. 2 is a diagram illustrating a configuration of projector 1 in FIGS. 1(A) and 1(B).

Referring to FIG. 2, projector 1 includes input terminals T1 and T2, a receiver portion 10, an image signal processing circuit 12, an OSD (On Screen Display) circuit 14, a DAC (Digital Analog Converter) 16, a liquid crystal panel drive portion 18, an optical portion 20, a projection lens 22, a lamp 24, a lamp drive portion 26, a power supply portion 28, a control unit 30, an image signal detection portion 32, and an operation acceptance portion 34.

Receiver portion 10 processes image signals provided from input terminals T1 and T2 and outputs the resultant signals. Specifically, receiver portion 10 has an ADC (Analog Digital Converter) function for converting a received analog image signal Vin to a digital image signal Din, and it receives an analog image signal Vin1 from input terminal T1 and outputs this signal as a digital image signal Din1. In addition, receiver portion 10 receives an analog image signal Vin2 from input terminal T2 and outputs this signal as a digital image signal Din2.

Image signal processing circuit 12 processes image signal Din output from receiver portion 10 to a signal for display and outputs the resultant signal. Specifically, when image signal Vin1 (or Vin2) is input only to single input terminal T1 (or T2), based on an instruction from control unit 30, image signal processing circuit 12 generates a digital image signal Dsc for one frame based on provided image signal Din1 (or Din2) such that an image based on this single image signal is displayed in main screen 100 (FIG. 1(A)).

On the other hand, when image signals are input to a plurality of input terminals T1 and T2, image signal processing circuit 12 generates digital image signal Dsc for one frame based on provided image signals Din1 and Din2 such that images based on these two image signals Vin1 and Vin2 are displayed in main screen 100 and sub screen 110 respectively (FIG. 1(B)).

In addition, image signal processing circuit 12 performs scaling processing for adapting to resolution of a liquid crystal light valve by scaling up and down an image represented by image signal Din, frame rate conversion processing indicating the number of times of rendering update within one second, gamma correction for converting a gradation value of image signal Dsc to a gradation value suitable for display on the liquid crystal light valve (not shown), and the like. Here, when image signals are input to a plurality of input terminals T1 and T2, image signal processing circuit 12 subjects image signals Din1 and Din2 to reduction processing and combination processing such that images based on two respective image signals are arranged in a prescribed layout as shown in FIG. 1(B). Image signal Din is subjected to such image signal processing and output as digital image signal Dsc.

OSD circuit 14 superimposes an image data signal based on information provided from control unit 30 on image signal Dsc output from image signal processing circuit 12 and outputs resultant image signal Dsc.

DAC 16 receives image signal Dsc output from OSD circuit 14 and outputs an analog image signal Vout subjected to D/A conversion.

In projector 1, liquid crystal panel drive portion 18, optical portion 20, projection lens 22, and lamp 24 correspond to the display portion for displaying an image on a projection screen SC under the control of control unit 30, in accordance with image signal Vout output from DAC 16.

An operation of the display portion will be described. Liquid crystal panel drive portion 18 is a liquid crystal driver, and it supplies image signal Vout to the liquid crystal light valve and projects an image on the liquid crystal light valve.

Though not shown, optical portion 20 includes an integrator optical system for converting white light emitted by lamp 24 to substantially collimated light, a separation optical system separating white light into light having each color component of red, green and blue representing primaries of light and supplying the light to the liquid crystal light valve for light of each color, and a combination optical system combining again light of each color modulated by the liquid crystal light valve in accordance with image signal Vout for light of each color. Modulated light for light of each color from the liquid crystal light valve is combined by a dichroic prism serving as the combination optical system and thereafter projected in a scaled-up manner by projection lens 22 on projection screen SC. Projection lens 22 includes a group of lenses for forming an image of projected light on projection screen SC and an actuator for displacing some lenses in the group of lenses in a direction of an optical axis so as to adjust a zoom state and a focused state of the projected image.

Power supply portion 28 is supplied with power through a plug inserted in a not-shown AC power outlet and it supplies the received power to each portion or unit within projector 1. Lamp drive portion 26 receives power from power supply portion 28 and generates a high voltage for turning on lamp 24.

Image signal detection portion 32 detects whether or not image signals are input to input terminals T1 and T2 respectively, by detecting image signal Din output from receiver portion 10. Image signal detection portion 32 outputs a result of detection as to presence/absence of input of an image signal to control unit 30.

Control unit 30 is implemented by a CPU (Central Processing Unit), and it exchanges a signal with each portion and controls an operation of each portion in response to an operation signal from operation acceptance portion 34.

Receiving the result of detection as to presence/absence of input of an image signal from image signal detection portion 32, control unit 30 further generates a switching indication for switching the display mode of projector 1, based on the result of detection. Control unit 30 outputs the generated switching indication to image signal processing circuit 12. Image signal processing circuit 12 switches between the single-screen display mode and the dual-screen display mode with the method described above, in accordance with the switching indication from control unit 30.

When an operation on an operation portion implemented by a plurality of operation buttons provided in a main body of projector 1 and a remote controller for remote control of projector 1 is performed, operation acceptance portion 34 accepts the operation and sends a command signal serving as a trigger for various operations.

FIG. 3 is a flowchart illustrating an operation of projector 1. Referring to FIG. 3, when image signal Vin from input portion 9 is input to receiver portion 10 (step S01), image signal detection portion 32 detects whether or not image signals are input to input terminals T1 and T2 respectively, by detecting an image signal output from receiver portion 10. Image signal detection portion 32 outputs the result of detection as to presence/absence of input of an image signal to control unit 30.

Control unit 30 determines whether the number of input terminals receiving an image signal from an external image source is one or not, based on the result of detection by image signal detection portion 32 (step S02). When it is determined that the number of input terminals receiving the image signal is one (determination as YES is made in step S02), projector 1 enters the single-screen display mode. Control unit 30 causes the display portion to project an image based on this single image signal.

On the other hand, when it is determined that the number of input terminals receiving the image signal is not one (determination as NO is made in step S02), control unit 30 further determines whether image signals are input to the plurality of input terminals T1 and T2 or not (step S04). When it is determined that image signals are input to the plurality of input terminals T1 and T2 (determination as YES is made in step S04), projector 1 enters the dual-screen display mode. Control unit 30 causes the display portion to project images based on the two respective image signals (step S05).

On the other hand, when it is determined that image signals are not input to the plurality of input terminals T1 and T2, that is, when neither of the input terminals receives the image signal (determination as NO is made in step S04), control unit 30 ends the processing without causing the display portion to project an image.

As described above, according to the first embodiment of the present invention, in a projector including a plurality of input terminals, an image displayed on the display portion is switched depending on presence/absence of input of image signals to the plurality of input terminals. Therefore, for example, during execution of the single-screen display mode, automatic switching to the dual-screen display mode is made at the time point of detection of input of a second image signal, whereas switching to the single-screen display mode is made again at the time point when input of the second image signal stopped. Thus, dual-screen display can be provided only in a necessary situation, without requiring the user to perform an operation for changing setting of the display mode. Consequently, convenience of the projector in displaying an image is improved.

It is noted that the user who is viewing an image may be caused to select activation/inactivation of a function to automatically switch the display mode depending on presence/absence of input of image signals to the plurality of input terminals described in the first embodiment above.

In addition, though a manner of switching between single-screen display and dual-screen display depending on presence/absence of input of an image signal has been described in the embodiment above, the present embodiment is similarly applicable also to multi-screen display in which three or more image signals are simultaneously displayed. In this case, the number of images to simultaneously be displayed on one screen may be switched depending on the number of input terminals at which input of image signals was detected by the image signal detection portion.

### Second Embodiment

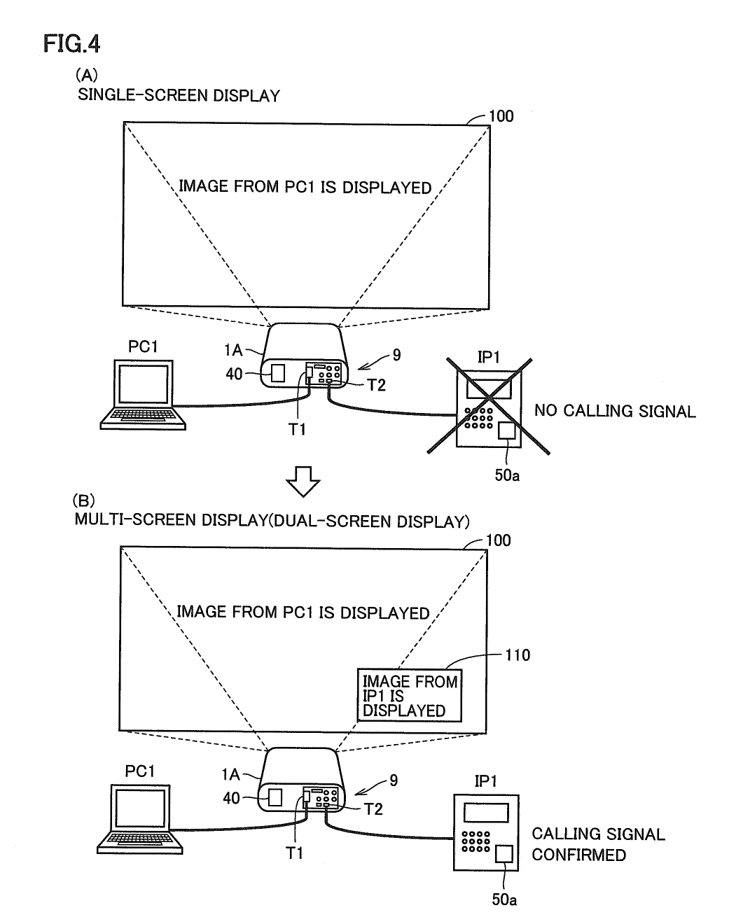

FIGS. 4(A) and 4(B) are diagrams illustrating an image displayed by a projector according to a second embodiment of the present invention.

Referring to FIG. 4(A), a projector 1A includes input portion 9 and an aural/oral communication portion 40. Input portion 9 includes a plurality of input terminals. In the present embodiment, by way of example, input portion 9 is assumed to include two input terminals T1 and T2.

Input terminal T1 is an RGB terminal and adapted to an analog RGB signal supplied from PC1. On the other hand, an intercom apparatus IP1 is connected to input terminal T2 through a wired or wireless transmission path.

Intercom apparatus IP1 is installed outdoors and it transmits and receives a signal to and from projector 1A. Projector 1A and intercom apparatus IP1 each include an aural/oral communication portion for mutual aural/oral communication. In addition, intercom apparatus IP1 includes an image pick-up portion picking up an image, for example, by using a CCD (Charge Coupled Device) camera, and projector 1A causes the display portion to project an image picked up by the image pick-up portion of intercom apparatus IP1. Thus, a face of a visitor who is present on intercom apparatus IP1 side can be checked on projector 1 side.

In addition, projector 1A according to the present embodiment has the single-screen display mode and the multi-screen display mode as the display modes. In the following, the dual-screen display mode is assumed as one manner of the multi-screen display mode.

Switching between the single-screen display mode and the dual-screen display mode is made based on presence/absence of input of an image signal to input portion 9, by using a prescribed signal (calling signal) transmitted from intercom apparatus IP1 as a trigger, as will be described below. It is noted that the calling signal is a signal output to input terminal T2 of projector 1A through the transmission path when a call button 50a provided in intercom apparatus IP1 is pressed by a visitor.

Specifically, referring to FIG. 4(A), an example where PC1 and intercom apparatus IP1 are connected to input terminals T1 and T2 respectively and image signals from PC1 and intercom apparatus IP1 can be input is assumed. In this example, while an image signal is input to input terminal T1 and a calling signal from intercom apparatus IP1 is not input to input terminal T2, projector 1A is set to the single-screen display mode. Therefore, an image based on an image signal from PC1 is displayed in main screen 100.

Then, when input of a calling signal to input terminal T2 is confirmed during execution of the single-screen display mode, projector 1 switches from the single-screen display mode to the dual-screen display mode. As shown in FIG. 4(B), projector 1A causes main screen 100 to display an image based on an image signal from PC1 and causes sub screen 110 to display an image based on an image signal from the image pick-up portion in intercom apparatus IP1 input to input terminal T2. In the example in FIG. 4(B), though sub screen 110 is arranged within a display area of main screen 100, a manner of arrangement and the size of each screen is not limited thereto.

During execution of the dual-screen display mode, aural/oral communication between projector 1 and intercom apparatus IP1 can further be enabled by using aural/oral communication portion 40 provided in projector 1A and an aural/oral communication portion (not shown) provided in intercom apparatus IP1. Therefore, the user of projector 1A can check a face of a visitor who is present on intercom apparatus IP1 side and talk with the visitor.

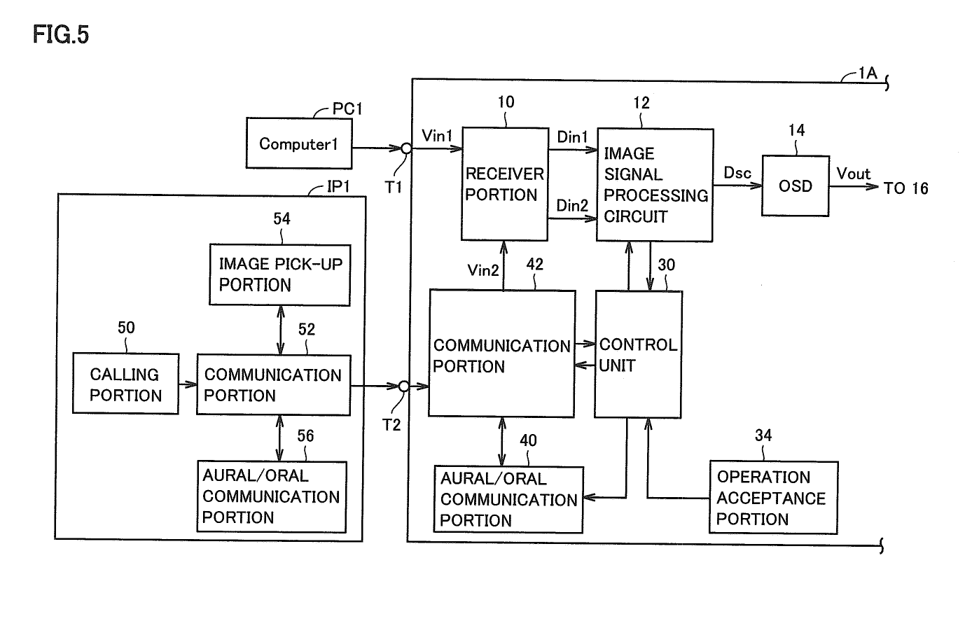

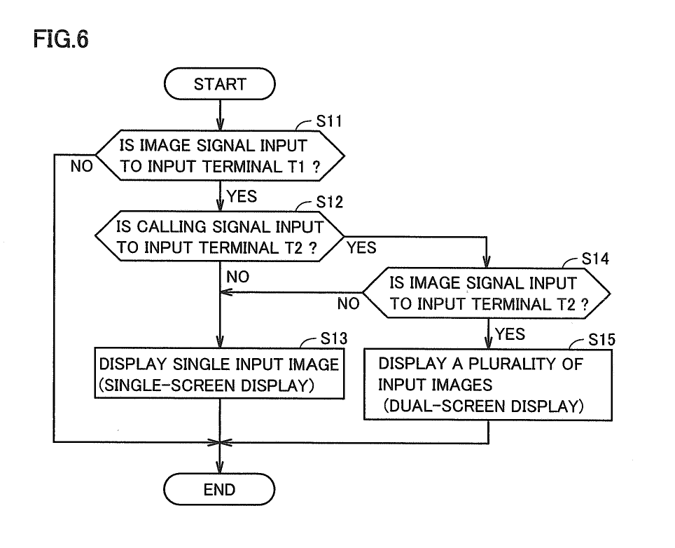

Control for switching between the display modes in projector 1A according to the second embodiment of the present invention will be described hereinafter with reference to FIGS. 5 and 6.

FIG. 5 is a diagram illustrating a configuration of projector 1A in FIGS. 4(A) and 4(B).

Referring to FIG. 5, projector 1A according to the present second embodiment is different from projector 1 in FIG. 2 only in including aural/oral communication portion 40 and communication portion 42, instead of image signal detection portion 32. Therefore, illustration and description of portions in FIG. 5, that are common to those in FIG. 2, will not be provided.

Receiver portion 10 is connected to input terminal T1 for connection to PC1 and connected to input terminal T2 for connection to intercom apparatus IP1, with communication portion 42 being interposed. Specifically, receiver portion 10 receives analog image signal Vin1 from input terminal T1 and outputs this signal as digital image signal Din1. In addition, receiver portion 10 receives image signal Vin2 from communication portion 42 and outputs this signal as digital image signal Din2.

Intercom apparatus IP1 is installed outdoors and it enables aural/oral communication with projector 1A installed indoors through the transmission path.

Intercom apparatus IP1 includes a calling portion 50, a communication portion 52, an image pick-up portion 54, and an aural/oral communication portion 56.

Calling portion 50 has a call button to be pressed by a visitor, and when the call button is operated, it outputs a prescribed calling signal to communication portion 42 of projector 1A through communication portion 52 and the transmission path.

Communication portion 52 transmits and receives a signal to and from communication portion 42 of projector 1A through the transmission path. A signal transmitted and received between communication portion 52 and communication portion 42 includes an image signal, an audio signal and a control signal.

Though not shown, image pick-up portion 54 includes an image pick-up device, a conversion circuit performing digital conversion of an output from the image pick-up device and generating image data, and a modulation circuit generating an image signal by modulating the image data output from the conversion circuit for multiplex transmission. A CCD type or CMOS type image pick-up device can be employed as the image pick-up device.

Though not shown, aural/oral communication portion 56 includes an aural transmission circuit converting input voice and sound to an audio signal which is an electric signal and transmitting the audio signal through communication portion 52 and the transmission path, an oral reception circuit converting the audio signal received through the transmission path and communication portion 52 to voice and sound, and an audio switch interposed between the aural transmission circuit, the oral reception circuit and communication portion 52 and comparing an audio signal input from the aural transmission circuit to communication portion 52 and an audio signal input from communication portion 52 to the oral reception circuit with each other, and switching a direction of aural/oral communication by attenuating a signal lower in signal level (that is, volume) and amplifying a signal higher in signal level. Specifically, the aural transmission circuit has a microphone converting voice and sound to an audio signal which is an electric signal. The oral reception circuit has a speaker converting an audio signal to voice and sound.

In projector 1A, communication portion 42 transmits and receives a signal to and from communication portion 52 of intercom apparatus IP1 through the transmission path. Communication portion 42 has a filtering circuit for filtering out an image signal, an audio signal and a control signal from a signal received through the transmission path.

Aural/oral communication portion 40 is configured similarly to aural/oral communication portion 56 of intercom apparatus IP1 and it includes an aural transmission circuit, an oral reception circuit and an audio switch.

Control unit 30 normally sets image pick-up portion 54 and aural/oral communication portions 40 and 56 to be inactive. When the call button in intercom apparatus IP1 is pressed, calling portion 50 of intercom apparatus IP1 transmits a calling signal to projector 1A. In projector 1A, when communication portion 42 receives the calling signal, control unit 30 starts up image pick-up portion 54 and causes image pick-up portion 54 to pick up an image. In addition, when communication portion 42 receives an image signal as a result of operation of image pick-up portion 54, control unit 30 generates a switching indication for switching the display mode of projector 1A and outputs the generated switching indication to image signal processing circuit 12.

When image signal processing circuit 12 causes switching from the single-screen display mode to the dual-screen display mode in response to the switching indication from control unit 30, an image based on image signal Vin2 from intercom apparatus IP1 is displayed in sub screen 110 as shown in FIG. 4(B). The user of projector 1A checks this image and determines whether to start aural/oral communication or not. If aural/oral communication is to be started, in response to acceptance by operation acceptance portion 34 of an operation to press an aural/oral communication button provided in the operation portion or the remote controller, control unit 30 activates aural/oral communication portions 40 and 56 of projector 1A and intercom apparatus IP1 respectively so as to enable aural/oral communication. On the other hand, if aural/oral communication is not to be started, the user does nothing so that control unit 30 inactivates image pick-up portion 54 and aural/oral communication portions 40 and 56 as a prescribed stand-by period expires.

FIG. 6 is a flowchart illustrating an operation of projector 1A.

Referring to FIG. 6, in step S11, control unit 30 determines whether image signal Vin1 is input to input terminal T1 or not (step S11). When it is determined that image signal Vin1 is not input to input terminal T1 (determination as NO is made in step S11), control unit 30 ends the processing without causing the display portion to project an image.

On the other hand, when it is determined that image signal Vin1 is input to input terminal T1 (determination as YES is made in step S11), control unit 30 determines whether the calling signal is input to input terminal T2 or not, by detecting presence/absence of reception of the calling signal by communication portion 42 (step S12). When it is determined that the calling signal is not input to input terminal T2 (determination as NO is made in step S12), projector 1A enters the single-screen display mode and control unit 30 causes the display portion to project the image based on single image signal Vin1.

On the other hand, when it is determined that the calling signal is input to input terminal T2 (determination as YES is made in step S12), control unit 30 activates image pick-up portion 54 and aural/oral communication portions 40 and 56. In step S14, control unit 30 determines whether image signal Vin2 is input to input terminal T2 or not. When it is determined that image signal Vin2 is input to input terminal T2 (determination as YES is made in step S14), projector 1A enters the dual-screen display mode. Control unit 30 causes the display portion to project images based on two respective image signals Vin1 and Vin2 (step S15).

On the other hand, when it is determined that image signal Vin2 is not input to input terminal T2 (determination as NO is made in step S14), control unit 30 causes the display portion to project an image based on single image signal Vin1 (step S13).

As described above, according to the second embodiment of the present invention, in a projector including a plurality of input terminals, an image displayed on the display portion is switched depending on presence/absence of input of an image signal to the input terminal to which a prescribed external image source is connected, using a prescribed signal received from the prescribed image source as a trigger. In the embodiment described above, when the calling signal from the intercom apparatus is received during execution of the single-screen display mode, automatic switching to the dual-screen display mode is made at the time point of detection of input of an image signal from the intercom apparatus.

In addition, at the time point when input of the image signal from the intercom apparatus stopped as the intercom apparatus enters a stand-by state, switching to the single-screen display mode is made again. Thus, in a single-screen display state, dual-screen display can be provided in a necessary situation (that is, in checking a visitor). Therefore, switching between single-screen display and dual-screen display can be made without separately providing an operation button or the like.

Though a manner of switching between single-screen display and dual-screen display using a prescribed signal input from a prescribed image source as a trigger has been described in the embodiment above, the present embodiment is similarly applicable also to multi-screen display in which three or more image signals are simultaneously displayed. In this case, the number of images to simultaneously be displayed on one screen may be switched depending on the number of input signals received by the communication portion.

### Third Embodiment

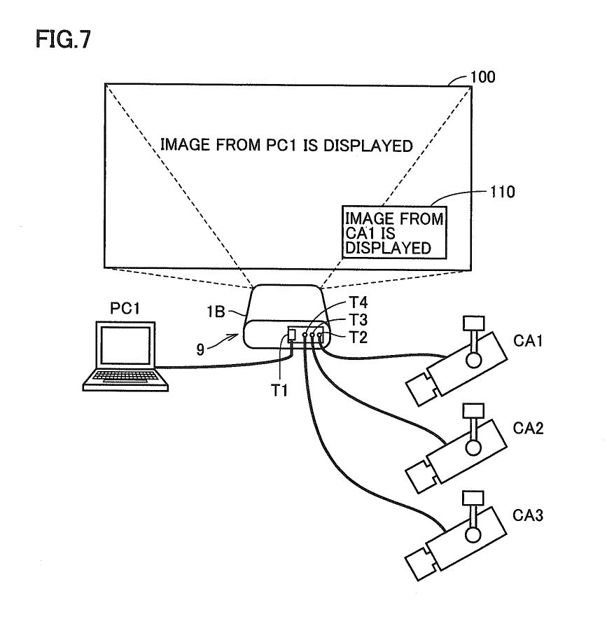

FIG. 7 is a diagram illustrating an image displayed by a projector according to a third embodiment of the present invention.

Referring to FIG. 7, a projector 1B includes input portion 9. Input portion 9 includes a plurality of input terminals. In the present embodiment, by way of example, input portion 9 is assumed to include four input terminals T1 to T4.

Input terminal T1 is an RGB terminal and adapted to an analog RGB signal supplied from PC1. On the other hand, image pick-up apparatuses CA1 to CA3 are connected to input terminals T2 to T4 through wired or wireless transmission paths, respectively.

Image pick-up apparatuses CA1 to CA3 are applied as surveillance cameras. Image pick-up apparatuses CA1 to CA3 output images picked up as apparatus main bodies are turned to change image pick-up areas. An image signal output from image pick-up apparatus CA1 is input to input terminal T2 of projector 1B through the transmission path. An image signal output from image pick-up apparatus CA2 is input to input terminal T3 of projector 1B through the transmission path. An image signal output from image pick-up apparatus CA3 is input to input terminal T4 of projector 1B through the transmission path. Projector 1B causes the display portion to project images picked up by image pick-up apparatuses CA1 to CA3 with a method which will be described later. Thus, images within prescribed image pick-up target areas can be checked on projector 1B side.

In addition, projector 1B according to the present embodiment has the single-screen display mode and the multi-screen display mode as the display modes. In the following, the dual-screen display mode is assumed as one manner of the multi-screen display mode.

Switching between the single-screen display mode and the dual-screen display mode is made based on presence/absence of input of image signals from image pick-up apparatuses CA1 to CA3 to input portion 9 as will be described below.

Specifically, an example where PC1 is connected to input terminal T1 and image pick-up apparatuses CA1 to CA3 are connected to input terminals T2 to T3 respectively and image signals from PC1 and image pick-up apparatuses CA1 to CA3 can be input is assumed. In this example, while an image signal is input to each of input terminals T1 to T4, projector 1B is set to the dual-screen display mode.

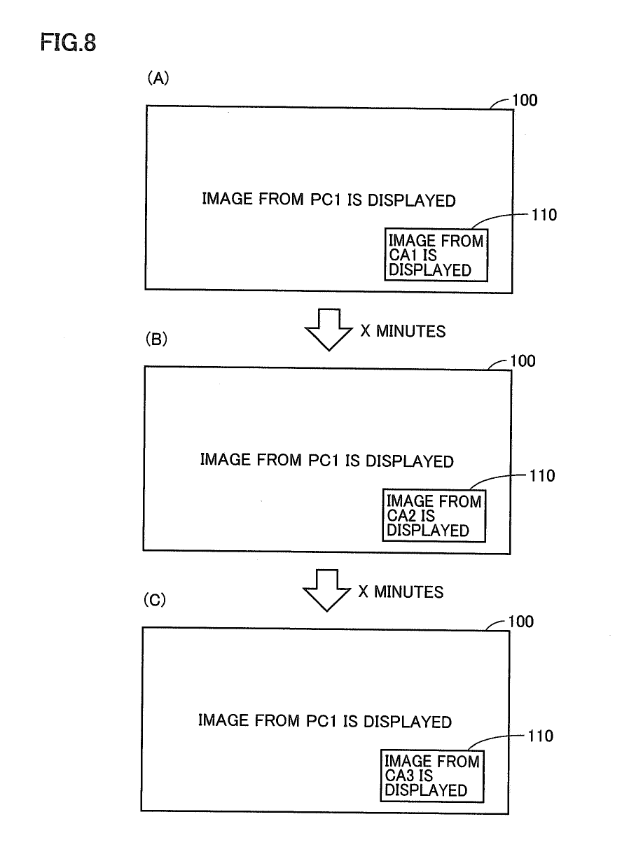

FIGS. 8(A), 8(B) and 8(C) are diagrams illustrating an image displayed by projector 1B during execution of the dual-screen display mode. As shown in FIG. 8(A), projector 1B causes main screen 100 to display an image based on an image signal from PC1 and causes sub screen 110 to display an image based on an image signal from image pick-up apparatus CA1 input to input terminal T2. In the example in FIG. 8(A), though sub screen 110 is arranged within a display area of main screen 100, a manner of arrangement and the size of each screen is not limited thereto.

Then, after a prescribed period of time (for example, set to X minutes) has elapsed since display of the image based on the image signal from image pick-up apparatus CA1 in sub screen 110, the image to be displayed in sub screen 110 is switched from the image signal from image pick-up apparatus CA1 to the image signal from image pick-up apparatus CA2, as shown in FIG. 8(B). In addition, after a prescribed period of time has elapsed since the timing of switching of the image in sub screen 110, the image to be displayed in sub screen 110 is switched from the image signal from image pick-up apparatus CA2 to the image signal from image pick-up apparatus CA3, as shown in FIG. 8(C).

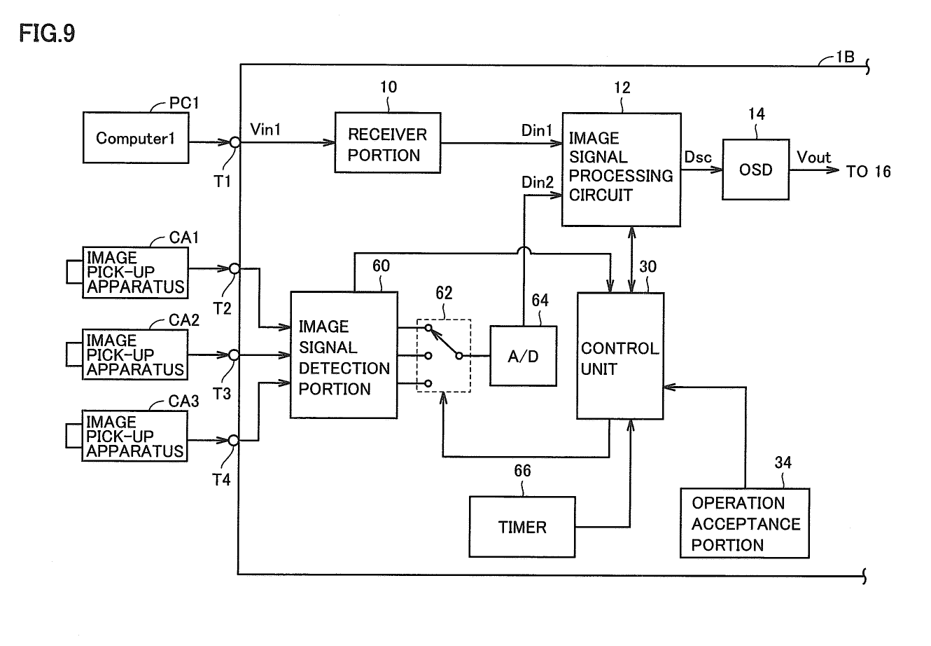

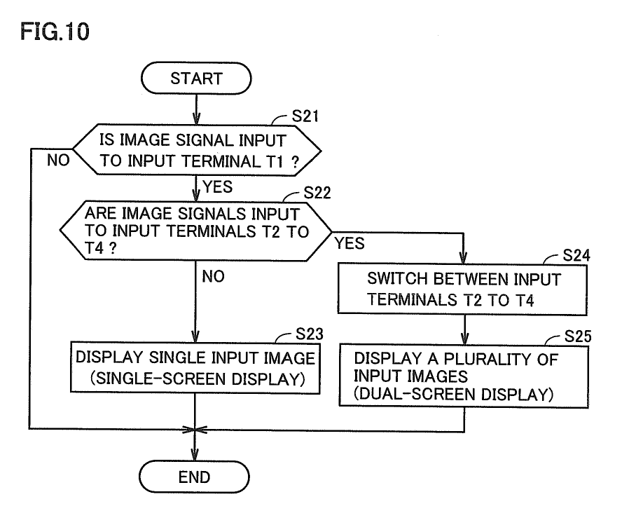

Thus, in projector 1B according to the present third embodiment, during execution of the dual-screen display mode, an image to be displayed in sub screen 110 is switched every prescribed period of time. Control for switching between the display modes in projector 1B according to the third embodiment of the present invention will be described hereinafter with reference to FIGS. 9 and 10.

FIG. 9 is a diagram illustrating a configuration of projector 1B in FIG. 7.

Referring to FIG. 9, projector 1B according to the present third embodiment is different from projector 1 in FIG. 2 only in including an image signal detection portion 60, an input switching portion 62, an A/D converter 64, and a timer 66, instead of image signal detection portion 32. Therefore, illustration and detailed description of portions in FIG. 9, that are common to those in FIG. 2, will not be provided.

Receiver portion 10 is connected to input terminal T1 for connection to PC1. Receiver portion 10 receives analog image signal Vin1 from input terminal T1 and outputs this signal as digital image signal Din1.

Image pick-up apparatuses CA1 to CA3 are connected to input terminals T2 to T4 respectively. Analog image signals output from image pick-up apparatuses CA1 to CA3 are input to image signal detection portion 60 through input terminals T2 to T4, respectively.

Image signal detection portion 60 detects whether image signals are input to respective input terminals T2 to T4 or not, based on detection of image signals input from input terminals T2 to T4. Image signal detection portion 60 outputs the result of detection as to presence/absence of input of image signals to control unit 30.

Input switching portion 62 selectively switches between three image signals output from image signal detection portion 60 under the control of control unit 30 and supplies one selected image signal to A/D converter 64. A/D converter 64 converts an analog signal supplied from input switching portion 62 to a digital signal and outputs the resultant signal to image signal processing circuit 12 as digital image signal Din2.

Timer 66 is implemented by using a time count function of an internal clock or the like of the CPU implementing control unit 30, and it starts time counting based on an instruction from control unit 30 and returns a count value to control unit 30.

Switching control by control unit 30 controls input switching portion 62 so as to switch between input image signals at prescribed timing, based on the result of detection by image signal detection portion 60. Specifically, when it is determined that image signals are input to at least two input terminals among input terminals T2 to T4 based on the result of detection by image signal detection portion 60, control unit 30 selects any one image signal out of at least two image signals and causes supply of the selected signal to A/D converter 64. Thus, projector 1B is set to the dual-screen display mode. Projector 1B displays the image based on the image signal input to input terminal T1 in main screen 100 and displays the image based on the selected image signal in sub screen 110.

When display of the image in sub screen 110 is started, control unit 30 instructs timer 66 to start counting. Then, control unit 30 successively obtains count values from timer 66 and monitors lapse of time since start of display in sub screen 110. When the count value from timer 66 attains to a prescribed period of time (X minutes), control unit 30 controls input switching portion 62 so as to switch between the image signals. As the input image signal is thus switched, an image displayed in sub screen 110 is switched to an image based on a new input image signal, as shown in FIGS. 8(B) and 8(C).

FIG. 10 is a flowchart illustrating an operation of projector 1B.

Referring to FIG. 10, in step S21, control unit 30 determines whether image signal Vin1 is input to input terminal T1 or not. When it is determined that image signal Vin1 is not input to input terminal T1 (determination as NO is made in step S21), control unit 30 ends the processing without causing the display portion to project an image.

On the other hand, when it is determined that image signal Vin1 is input to input terminal T1 (determination as YES is made in step S21), control unit 30 further determines whether image signals are input to input terminals T2 to T4 or not (step S22). When it is determined that an image signal is input to none of input terminals T2 to T4 (determination as NO is made in step S22), projector 1B enters the single-screen display mode and control unit 30 causes the display portion to project an image based on single image signal Vin1.

On the other hand, when it is determined that image signals are input to input terminals T2 to T4 (determination as YES is made in step S22), projector 1B enters the dual-screen display mode. Control unit 30 successively obtains count values from timer 66 and controls input switching portion 62 so as to switch between the image signals every prescribed period of time (X minutes) based on the obtained count value (step S24). Then, control unit 30 causes the display portion to project images based on two respective image signals Vin1 and Vin2 (step S25).

As described above, according to the third embodiment of the present invention, when input of image signals from a plurality of image pick-up apparatuses (surveillance cameras) is detected in a projector including a plurality of input terminals, switching to the dual-screen display mode is made and the image signals from the plurality of image pick-up apparatuses are switched every prescribed period of time for display on the display portion. Thus, in a single-screen display state, dual-screen display can be provided in a necessary situation (surveillance by the surveillance cameras). Therefore, switching between single-screen display and dual-screen display can be made without separately providing an operation button or the like.

In addition, since image signals from a plurality of image pick-up apparatuses can cyclically be switched for display in a dual-screen display state, an operation for switching display is not necessary and convenience of the projector is improved.

Though a manner of switching between image signals input from a plurality of image sources in dual-screen display has been described in the embodiment above, the present embodiment is similarly applicable also to multi-screen display in which three or more image signals are simultaneously displayed.

### Fourth Embodiment

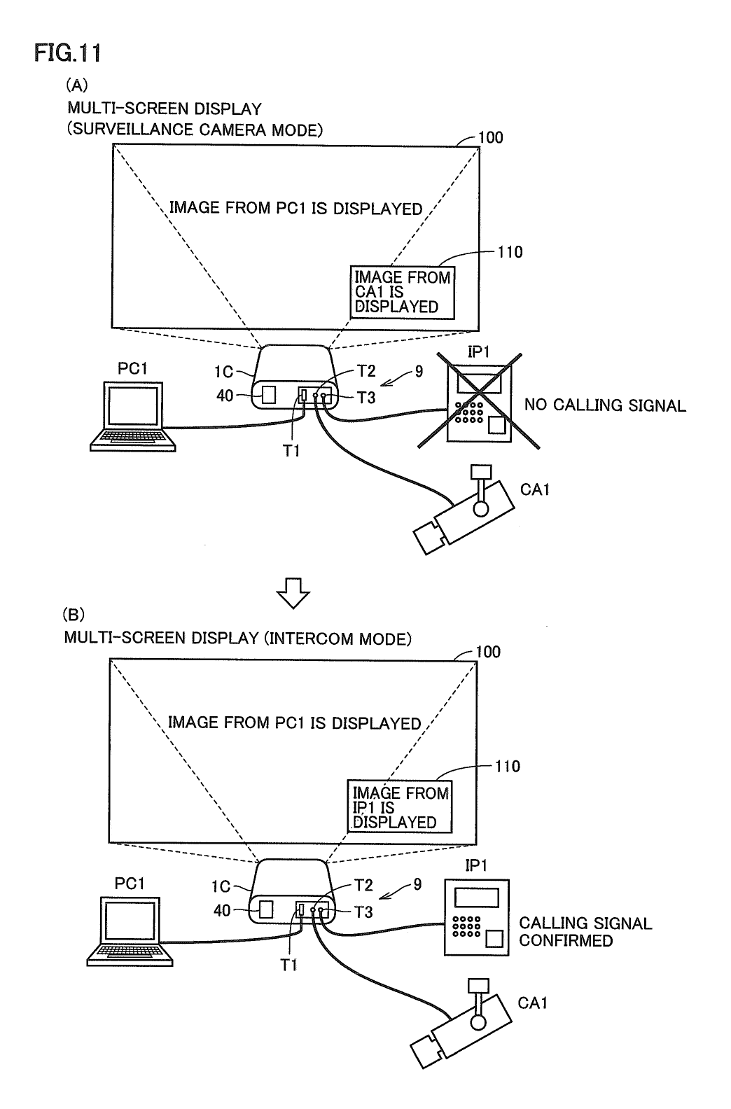

FIGS. 11(A) and 11(B) are diagrams illustrating an image displayed by a projector according to a fourth embodiment of the present invention.

Referring to FIG. 11(A), a projector 1C includes input portion 9 and aural/oral communication portion 40. Input portion 9 includes a plurality of input terminals. In the present embodiment, by way of example, input portion 9 is assumed to include three input terminals T1 to T3.

Input terminal T1 is an RGB terminal and adapted to an analog RGB signal supplied from PC1. Image pick-up apparatus CA1 is connected to input terminal T2 through a wired or wireless transmission path. Intercom apparatus IP1 is connected to input terminal T3 through a wired or wireless transmission path.

Image pick-up apparatus CA1 is implemented, for example, as a surveillance camera, and outputs an image picked up as an apparatus main body is turned to change an image pick-up area. An image signal output from image pick-up apparatus CA1 is input to input terminal T2 of projector 1C through the transmission path.

Intercom apparatus IP1 is configured similarly to intercom apparatus IP1 described with reference to FIG. 4 and transmits and receives a signal to and from projector 1C.

Projector 1C according to the present embodiment has the single-screen display mode and the multi-screen display mode as the display modes. In the following, the dual-screen display mode is assumed as one manner of the multi-screen display mode.

Switching between the single-screen display mode and the dual-screen display mode is made based on presence/absence of input of an image signal to input portion 9. Specifically, referring to FIG. 11(A), an example where PC1, image pick-up apparatus CA1 and intercom apparatus IP1 are connected to input terminals T1, T2 and T3 respectively and image signals from PC1, image pick-up apparatus CA1 and intercom apparatus IP1 can be input is assumed. In this example, while an image signal is input to each of input terminals T1 and T2 and a calling signal from intercom apparatus IP1 is not input to input terminal T3, projector 1C is set to the dual-screen display mode. Here, projector 1C causes main screen 100 to display an image based on an image signal from PC1 and causes sub screen 110 to display an image based on an image signal from image pick-up apparatus CA1 input to input terminal T2. In the following, a mode in such a dual-screen display state, for displaying an image from image pick-up apparatus CA1 in one screen out of two screens, is also referred to as a “surveillance camera mode.” In the example in FIG. 11(A), though sub screen 110 is arranged within a display area of main screen 100, a manner of arrangement and the size of each screen is not limited thereto.

When input of a calling signal to input terminal T3 is confirmed during execution of the surveillance camera mode described above, projector 1C switches an image to be displayed in sub screen 110 from the image based on the image signal from image pick-up apparatus CA1 to an image based on an image signal from the image pick-up portion within intercom apparatus IP1, as shown in FIG. 11(B). In the following, a mode in such a dual-screen display state, for displaying an image from intercom apparatus IP1 in one screen out of two screens, is also referred to as an “intercom mode.”

During execution of the intercom mode, aural/oral communication between projector 1C and intercom apparatus IP1 can further be enabled by using the aural/oral communication portion provided in projector 1C and the aural/oral communication portion provided in intercom apparatus IP1.

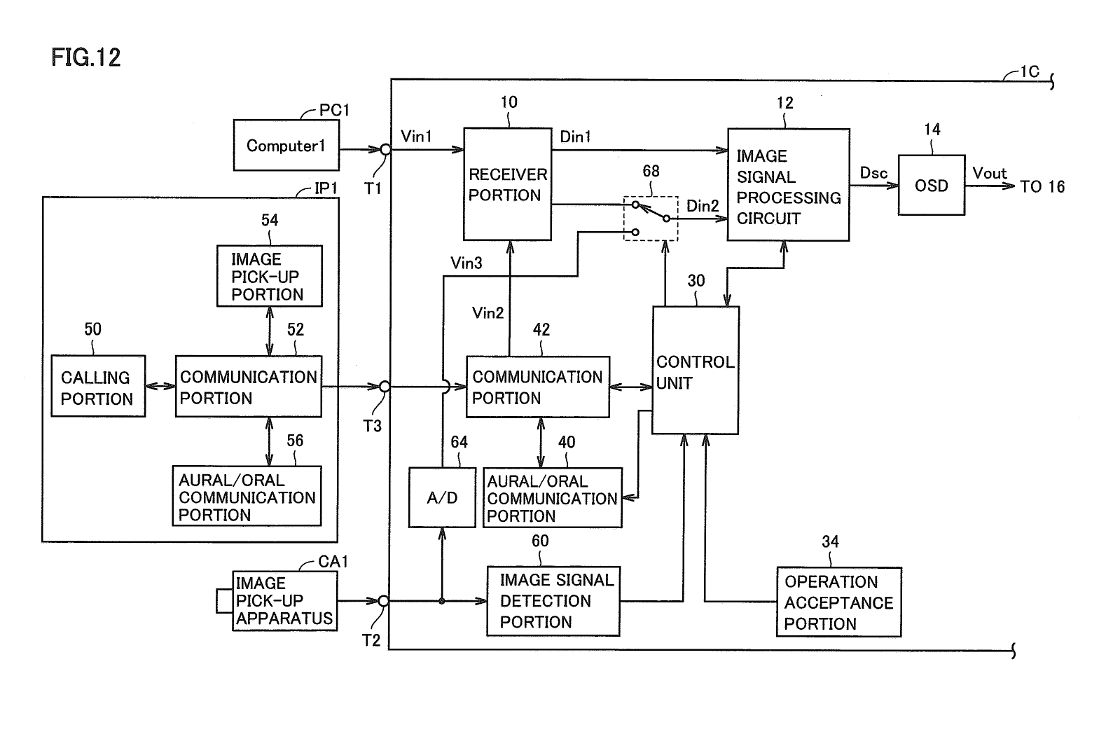

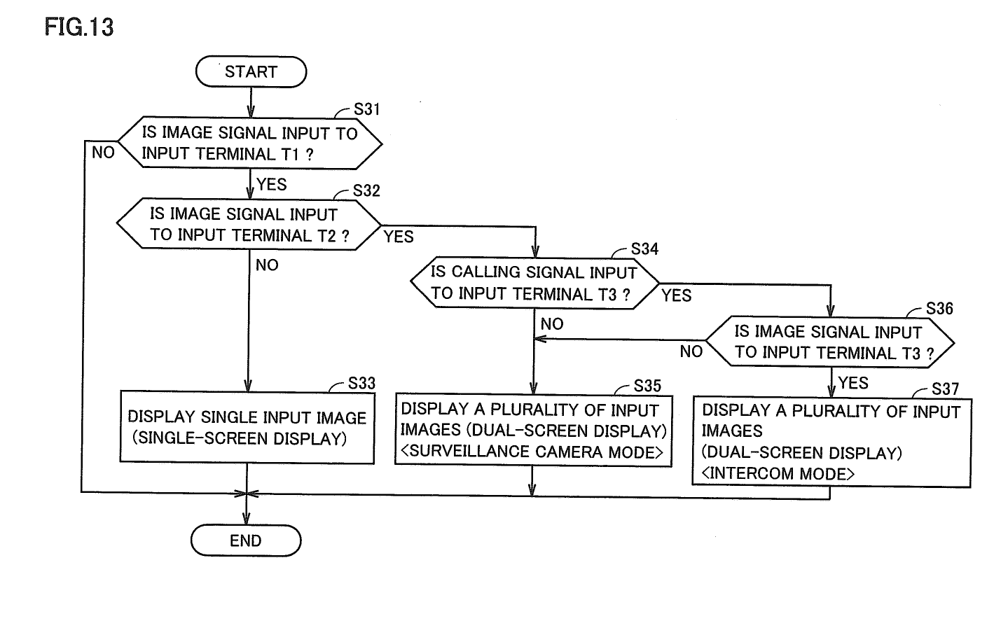

Control for switching between the display modes in the projector according to the fourth embodiment of the present invention will be described hereinafter with reference to FIGS. 12 and 13.

FIG. 12 is a diagram illustrating a configuration of projector 1C in FIGS. 11(A) and 11(B).

Referring to FIG. 12, projector 1C according to the present fourth embodiment is different from projector 1 in FIG. 2 only in including aural/oral communication portion 40, communication portion 42, image signal detection portion 60, A/D converter 64, and an input switching portion 68, instead of image signal detection portion 32. Therefore, illustration and description of portions in FIG. 12, that are common to those in FIG. 2, will not be provided.

Receiver portion 10 is connected to input terminal T1 for connection to PC1 and to input terminal T3 for connection to intercom apparatus IP1, with communication portion 42 being interposed. Specifically, receiver portion 10 receives analog image signal Vin1 from input terminal T1 and outputs this signal as digital image signal Din1. In addition, receiver portion 10 receives image signal Vin2 from communication portion 42 and outputs this signal to input switching portion 68 as a digital image signal.

Intercom apparatus IP1 is installed outdoors and it enables aural/oral communication with projector 1C installed indoors through the transmission path. Intercom apparatus IP1 includes calling portion 50, communication portion 52, image pick-up portion 54, and aural/oral communication portion 56. The configuration of intercom apparatus IP1 is the same as described with reference to FIG. 5. In projector 1C, communication portion 42 transmits and receives a signal to and from communication portion 52 in intercom apparatus IP1 through the transmission path. Communication portion 42 has a filtering circuit for filtering out an image signal, an audio signal and a control signal from a signal received through the transmission path. Aural/oral communication portion 40 is configured similarly to aural/oral communication portion 56 of intercom apparatus IP1 and it includes an aural transmission circuit, an oral reception circuit and an audio switch.

Control unit 30 normally sets image pick-up portion 54 and aural/oral communication portions 40 and 56 to be inactive. When a call button in intercom apparatus IP1 is pressed, calling portion 50 of intercom apparatus IP1 transmits a calling signal to projector 1C. In projector 1C, when communication portion 42 receives the calling signal, control unit 30 starts up image pick-up portion 54 and causes image pick-up portion 54 to pick up an image.

Image signal detection portion 60 detects whether an image signal is input to input terminal T2 or not, based on detection of the image signal input from input terminal T2. Image signal detection portion 60 outputs the result of detection as to presence/absence of input of the image signal to control unit 30.

A/D converter 64 converts an analog image signal supplied from input terminal T2 to a digital signal and outputs the resultant signal to input switching portion 68 as a digital image signal.

Input switching portion 68 selectively switches between the image signal output from receiver portion 10 (that is, the image signal from intercom apparatus IP1) and the image signal output from A/D converter 64 (that is, the image signal from image pick-up apparatus CA1) under the control of control unit 30. Then, control unit 30 causes supply of one selected image signal to image signal processing circuit 12 as digital image signal Din2.

When image signal processing circuit 12 switches the display mode from the single-screen display mode to the dual-screen display mode in response to a switching indication from control unit 30, an image based on image signal Din2 from any one of intercom apparatus IP1 and image pick-up apparatus CA1 is displayed in sub screen 110.

Here, switching control by control unit 30 controls input switching portion 68 so as to select one image signal in accordance with predetermined priority, based on the result of detection by image signal detection portion 60 and on a signal from communication portion 42. Specifically, when the image signal from image pick-up apparatus CA1 and the image signal from intercom apparatus IP1 are input to input switching portion 68, control unit 30 selects the image signal from intercom apparatus IP1 and causes supply of the selected signal to image signal processing circuit 12. Meanwhile, when only any one of the image signal from image pick-up apparatus CA1 and the image signal from intercom apparatus IP1 is input to input switching portion 68, that input image signal is selected and supplied to image signal processing circuit 12.

Thus, projector 1C is set to the dual-screen display mode and displays an image based on an image signal input to input terminal T1 in main screen 100 and displays an image based on a selected image signal in sub screen 110. Then, when an image signal higher in priority than the image signal currently displayed in sub screen 110 is input in this dual-screen display state, an image displayed in sub screen 110 is switched so as to display the subsequently input image signal.

In the present embodiment, when an image signal from intercom apparatus IP1 is input while an image based on an image signal from image pick-up apparatus CA1 is being displayed in sub screen 110 as shown in FIG. 11(A), that is, during execution of the surveillance camera mode, switching to the intercom mode is made as shown in FIG. 11(B) and the image based on the image signal from intercom apparatus IP1 is displayed in sub screen 110.

Then, in the intercom mode, the user of projector 1C checks this image and determines whether to start aural/oral communication or not. If aural/oral communication is to be started, in response to acceptance by operation acceptance portion 34 of an operation to press an aural/oral communication button provided in the operation portion or the remote controller, control unit 30 activates aural/oral communication portions 40 and 56 of projector 1C and intercom apparatus IP1 respectively so as to enable aural/oral communication. On the other hand, if aural/oral communication is not to be started, the user does nothing so that control unit 30 inactivates image pick-up portion 54 and aural/oral communication portions 40 and 56 as a prescribed stand-by period expires. Thus, projector 1C returns to the surveillance camera mode and the image based on the image signal from image pick-up apparatus CA1 is again displayed in sub screen 110.

Though intercom apparatus IP1 is set to have priority higher than image pick-up apparatus CA1 in the present embodiment, the user can change this priority.

FIG. 13 is a flowchart illustrating an operation of projector 1C.

Referring to FIG. 13, in step S31, control unit 30 determines whether image signal Vin1 is input to input terminal T1 or not. When it is determined that the image signal is not input to input terminal T1 (determination as NO is made in step S31), control unit 30 ends the processing without causing the display portion to project an image.

On the other hand, when it is determined that image signal Vin1 is input to input terminal T1 (determination as YES is made in step S31), control unit 30 further determines whether the image signal from image pick-up apparatus CA1 is input to input terminal T2 or not (step S32). When it is determined that the image signal is not input to input terminal T2 (determination as NO is made in step S32), projector 1C enters the single-screen display mode and control unit 30 causes the display portion to display the image based on single image signal Vin1 (step S33).

On the other hand, when it is determined that the image signal from image pick-up apparatus CA1 is input to input terminal T2 (determination as YES is made in step S32), projector 1C enters the dual-screen display mode. Control unit 30 determines whether the calling signal is input to input terminal T3 or not, by detecting presence/absence of reception of the calling signal by communication portion 42 (step S34). When it is determined that the calling signal is not input to input terminal T3 (determination as NO is made in step S34), projector 1C enters the surveillance camera mode and control unit 30 causes sub screen 110 to display the image based on the image signal from image pick-up apparatus CA1.

On the other hand, when it is determined that the calling signal is input to input terminal T3 (determination as YES is made in step S34), control unit 30 activates image pick-up portion 54 and aural/oral communication portions 40 and 56.

In step S36, control unit 30 determines whether the image signal from image pick-up portion 54 is input to input terminal T3 or not. When it is determined that the image signal is input to input terminal T3 (determination as YES is made in step S36), projector 1C enters the intercom mode. Control unit 30 causes sub screen 110 to display the image based on the image signal from intercom apparatus IP1 (step S37).

On the other hand, when it is determined that the image signal is not input to input terminal T3 (determination as NO is made in step S36), the surveillance camera mode is maintained. Control unit 30 causes sub screen 110 to display the image based on the image signal from image pick-up apparatus CA1 (step S35).

As described above, according to the fourth embodiment of the present invention, when input of image signals from a plurality of image sources is detected in a projector including a plurality of input terminals, switching to the dual-screen display mode is made and an image signal selected in accordance with predetermined priority from among image signals from the plurality of image sources is displayed on the display portion. Thus, for example, even under surveillance by a surveillance camera, the displayed image is automatically switched and a visitor can be checked. Therefore, display switching can be made with good operability, without separately providing an operation button or the like.

Though a manner of switching between image signals input from a plurality of image sources in dual-screen display has been described in the embodiment above, the present embodiment is similarly applicable also to multi-screen display in which three or more image signals are simultaneously displayed.

Though a liquid crystal projector has been adopted as the projector in the first to fourth embodiments described above, the embodiment is not limited as such. For example, the technique according to the present invention may be adopted in a projector of other type such as a DLP® (Digital Light Processing) projector.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image display apparatus having a single-screen display mode in which an image based on a single image signal is displayed and a multi-screen display mode in which a plurality of images based on a plurality of image signals respectively are displayed, comprising:
an input portion which includes a plurality of input terminals and receives a plurality of image signals supplied from a plurality of external image signal supply apparatuses through said plurality of input terminals respectively;
a display portion which displays an image based on the image signal input to said input portion;
an image signal detection portion which detects presence/absence of input of the image signal to said input portion; and
a control unit which switches an image to be displayed on said display portion based on a result of detection by said image signal detection portion, and
said control unit including a first display switching unit which switches between said single-screen display mode and said multi-screen display mode based on presence/absence of input of the image signal to an input terminal other than one input terminal while the image signal is input to said one input terminal among said plurality of input terminals.

2. The image display apparatus according to claim 1, further comprising a communication portion which transmits and receives a signal to and from a first image signal supply apparatus among said plurality of image signal supply apparatuses, wherein
said image signal detection portion detects presence/absence of input of a first image signal from said first image signal supply apparatus to said input portion, by using a prescribed signal received from said first image signal supply apparatus through said communication portion as a trigger, and
said control unit further includes a second display switching unit which switches between display and non-display of an image based on said first image signal on said display portion based on presence/absence of input of said first image signal to said input portion.

3. The image display apparatus according to claim 1, wherein
said control unit further includes a third display switching unit which switches between respective images based on a plurality of image signals every prescribed period of time so as to cause said display portion to display the images when said image signal detection portion detects input of the plurality of image signals to said input portion.

4. The image display apparatus according to claim 1, wherein
said control unit further includes a fourth display switching unit which selects at least one image signal from among a plurality of image signals in accordance with predetermined priority and causes said display portion to display an image based on selected said at least one image signal when said image signal detection portion detects input of the plurality of image signals to said input portion.
